(19) United States
(12) Patent Application Publication
(10) Pub. No.: US 2009/0304427 A1
(43) Pub. Date: Dec. 10, 2009

(54) IMAGE FORMING APPARATUS

(75) Inventor: Satoshi HAMAYA, Tokyo (JP)

Correspondence Address: CANTOR COLBURN, LLP, 20 Church Street, 22nd Floor, Hartford, CT, 06103, US

(73) Assignee: KONICA MINOLTA BUSINESS TECHNOLOGIES, INC., Tokyo (JP)

(21) Appl. No.: 12/478,718

(22) Filed: Jun. 4, 2009

(30) Foreign Application Priority Data
Jun. 9, 2008 (JP) 2008-150295

(51) Int. Cl. G03G 15/00

(52) U.S. Cl. 399/400

(57) ABSTRACT

An image forming apparatus includes: an image forming section for forming a toner image on a sheet; a fixing device for fixing the toner image on the sheet with heat; a reversal conveyance section which reverses a conveyance direction of the sheet which has passed through the fixing device; a conveyance member provided at the reversal conveyance section which is changed to be in either one of a conveyance state in which the conveyance member is in contact with an image supporting surface of the sheet, and to be in an evacuated state in which the conveyance member is separated from the image supporting surface of the sheet; and a switching mechanism for switching the conveyance member to be in one of the conveyance state and the evacuated state.

### CROSS REFERENCE TO RELATED APPLICATION

The present application is based on Japanese Patent Application No. 2008-150295 filed with Japanese Patent Office on Jun. 9, 2008, and the entire content of which is hereby incorporated by reference.

### BACKGROUND OF THE INVENTION

1. Field of Technology

The present invention relates to an image forming apparatus of an electrophotographic method, particularly relates to improvement of a conveyance section for conveying a sheet onto which a fixing process has been performed.

2. Description of Related Art

In the image forming apparatus of an electrophotographic method, a toner image is fixed onto a sheet by heat and pressure.

In recent years, in keeping with high-definition and colorization, wax is contained in toner. Moreover, the amount of wax contained in the toner is increasing. The wax is contained in the toner for a prevention of offset, an improvement of separatability of a sheet from a pair of fixing rollers and an adjustment of glossiness of a toner image.

However, the wax is not solidified immediately after the fixing process. Therefore, there may be a case in which the surface of the toner image becomes uneven. Then in case when a toner image on a sheet comes in contact with parts that configure a conveyance section in the lower stream of a fixing device, uneven glossiness occurs and the quality of the toner image is reduced.

In Unexamined Japanese Patent Application Publication No. 2005-234170, in order to prevent such deterioration of image quality, a spur that has needlelike tips in the conveyance section is provided and an image supporting surface of a sheet is guided.

The conveyance section, which conveys a sheet that has passed through the fixing device, includes a straight sheet ejection section that conveys a sheet kept in the same state as the sheet passed through the fixing device and ejects the sheet to outside of the image forming apparatus, a reversal sheet ejection section that ejects the sheet, which has been reversed after the sheet has passed through the fixing device, to outside the image forming apparatus, a reversal conveyance section that reverses the sheet and a conveyance switching member that selects these conveyance sections. Therefore, the configuration of the conveyance section is complicated.

It is very difficult to provide the spur, which is disclosed in Unexamined Japanese Patent Application Publication No. 2005-234170, into a conveyance section that has a complicated configuration and is dense with parts.

Therefore, it is very difficult to solve the problem of occurrence of uneven glossiness.

In case when a component that uniformly contacts the entire image supporting surface of the sheet, such as the pair of conveyance rollers and the guide members, even when the degree of glossiness changes to a certain degree, the degree of glossiness uniformly changes over the image supporting surface with the contact of this component. Therefore, the deterioration of image quality is reduced and does not become a problem in many cases.

However, in case when a component only comes in contact with a part of the image supporting surface of the sheet, the glossiness becomes uneven and the deterioration of image quality poses a problem.

In the reversal sheet ejection section, which reverses the sheet that has passed through the fixing device, the sheet is divided into two sections at a point in which the conveyance direction is reversed for the reversal of the sheet. One of the two sections is a section that does not come in contact with the component, such as the conveyance rollers and the guide members. The other section of the two sections is a section that comes in contact with the component, such as the conveyance rollers and the guide members.

Therefore, the uneven glossiness of a toner image occurs in an ejection mode that performs the reversal sheet ejection.

An object of the present invention is to provide an image forming apparatus that solves such a problem, prevents the uneven glossiness of a toner image and forms a high quality image.

### SUMMARY OF THE INVENTION

One aspect of the present invention is to provide an image forming apparatus including: an image forming section for forming a toner image on a sheet; a fixing device for fixing the toner image on the sheet with heat; a reversal conveyance section which reverses a conveyance direction of the sheet which has passed through the fixing device; a conveyance member provided at the reversal conveyance section which is changed to be in either one of a conveyance state in which the conveyance member is in contact with an image supporting surface of the sheet, and to be in an evacuated state in which the conveyance member is separated from the image supporting surface of the sheet; and a switching mechanism for switching the conveyance member to be in one of the conveyance state and the evacuated state.

### BRIEF DESCRIPTION OF THE DRAWINGS

FIG. 1 illustrates an entire configuration of a color image forming apparatus being an image forming apparatus that pertains to an embodiment of the present invention;

FIG. 2 illustrates a fixing device and a conveyance section in the image forming apparatus pertaining to an embodiment of the present invention;

FIG. 3 illustrates a diagram describing a generation of uneven glossiness;

FIGS. 4a and 4b illustrate diagrams, each describing illustrate diagram describing a conveyance state and an evacuated state of a pair of registration rollers;

FIG. 5 illustrates a block diagram of a control system;

FIG. 6 illustrates a flow chart showing a first example of a reversal sheet ejection control;

FIG. 7 illustrates a flow chart showing a second example of the reversal sheet ejection control; and

FIG. 8 illustrates a flow chart showing a third example of the reversal sheet ejection control.

### DETAILED DESCRIPTION OF THE PREFERRED EMBODIMENTS

Hereafter, the present invention will be described with a embodiment of the present invention. However, the present invention is not limited to this embodiment.

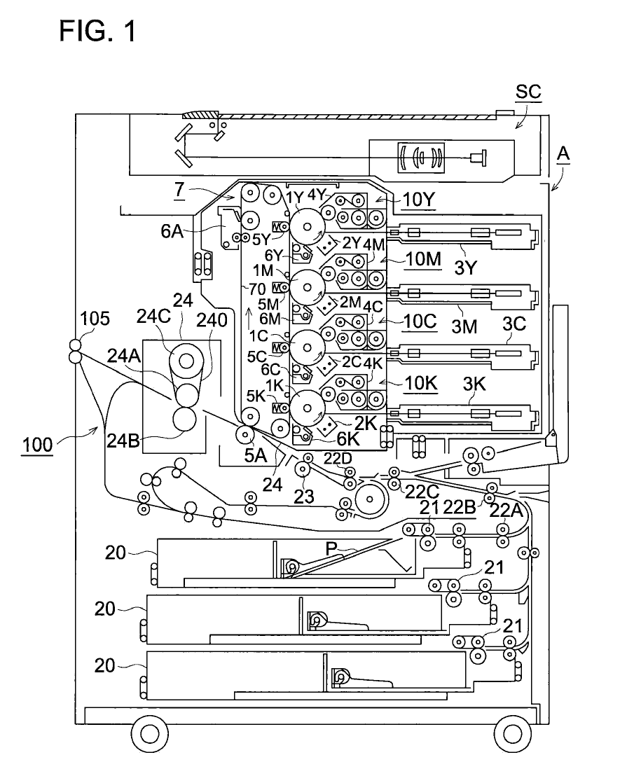

FIG. 1 illustrates an entire configuration of a color image forming apparatus being an image forming apparatus that pertains to an embodiment of the present invention.

The color image forming apparatus superimposes and transfers a toner image, which is formed on a photoreceptor, onto an intermediate transfer member. Then the color image forming apparatus collectively transfers the superimposed toner image onto a sheet.

This color image forming apparatus is configured by a plurality of sets of image forming units 10Y, 10M, 10C and 10K, an intermediate transfer unit 7, a sheet feed conveyance device and a fixing device 24. A document image reading apparatus SC is arranged on the upper section of an image forming apparatus main body A.

The plurality of sets of image forming units 10Y, 10M, 10C and 10K and the intermediate transfer unit 7 configure an image forming section for forming a toner image on a sheet P.

The image forming unit 10Y, which forms a yellow color toner image, includes a charging device 2Y, an exposure device 3Y, a development device 4Y, a primary transfer device 5Y and a cleaning device 6Y that are all arranged around a photoreceptor 1Y. The image forming unit 10M, which forms a magenta color toner image, includes a charging device 2M, an exposure device 3M, a development device 4M, a primary transfer device 5M and a cleaning device 6M that are all arranged around a photoreceptor 1M. The image forming unit 10C, which forms a cyan color toner image, includes a charging device 2C, an exposure device 3C, a development device 4C, a primary transfer device 5C and a cleaning device 6C that are all arranged around a photoreceptor 1C. The image forming unit 10K, which forms a black color toner image, includes a charging device 2K, an exposure device 3K, a development device 4K, a primary transfer device 5K and a cleaning device 6K that are all arranged around a photoreceptor 1K. In each image forming unit 10, charging, exposure and development are performed and a toner image of each color is formed onto a photoreceptor.

The intermediate transfer unit 7 is wound around a plurality of rollers, and has a semiconductive endless belt shaped intermediate transfer member 70 rotatably supported.

A toner image of each color formed from the image forming units 10Y, 10M, 10C and 10K is sequentially superimposed and transferred onto the rotating intermediate transfer member 70 by primary transfer devices 5Y, 5M, 5C and 5K. Then a synthesized color toner image is formed. A sheet P loaded in a sheet feeding cassette 20 is fed by a sheet feeding device 21. Then the sheet P is conveyed to a secondary transfer device 5A through a plurality of pairs of intermediate conveyance rollers 22A, 22B, 22C and 22D and a pair of registration rollers 23. The color toner image superimposed on the intermediate transfer member 70 is collectively transferred onto the sheet P. The fixing device 24 performs a fixing process to the sheet P onto which the color toner image is transferred.

The fixing device 24 has a support roller 24A, a pressure roller 24B, a heat source 24C and a heating belt 24D. The support roller 24A supports the heating belt 24D.

In the conveyance section 100, the sheet P that has passed through the fixing device 24 and onto which the fixing process has been performed, is ejected by a pair of sheet ejection rollers 105 in a face up state in which the image supporting surface of the sheet P is facing up via the straight sheet ejection section 101 that will be described later. In the conveyance section 100, the sheet P may be ejected in a face down state in which the image supporting surface of the sheet P is facing down via a reversal sheet ejection section 102 that will be described later. In the conveyance section 100, the sheet P may be re-fed into the image forming section for forming an image on the other side of the sheet P via a sheet re-feeding section 104 that will be described later.

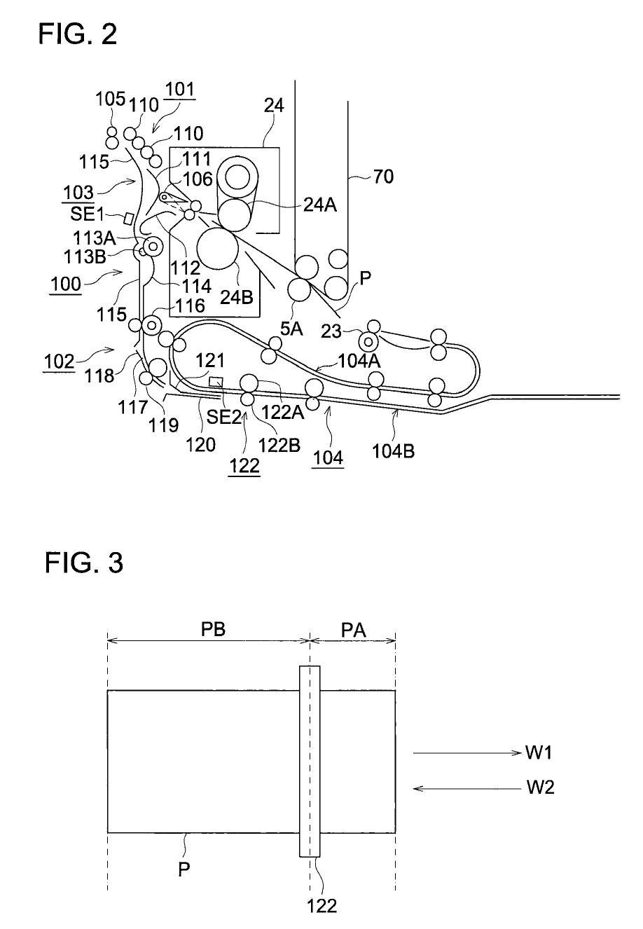

The conveyance section 100 will be described later using FIG. 2 onward.

On the other hand, after the color toner image is transferred onto the sheet P by the secondary transfer device 5A, a cleaning device 6A removes the residual toner from the intermediate transfer member 70, which has performed a curling separation on the sheet P.

While performing the image forming process, the primary transfer device 5K is kept in pressure contact with the photoreceptor 1K at all time. The other primary transfer devices 5Y, 5M and 5C are in pressure contact with the photoreceptors 1Y, 1M and 1C, respectively, only at the time of color image formation.

Next, the conveyance section 100 will be described in reference to FIG. 2 and beyond.

In the following descriptions, “upper stream”, “lower stream”, “leading edge of a sheet”, and “rear edge of a sheet” are used on the basis of the flow of a sheet.

In the conveyance section 100, the flow of a sheet may be reversed, that is, the flow of a sheet may switchback. In this case, the upper stream and the leading edge of a sheet before the switchback become the lower stream and a rear edge of a sheet, respectively, after the switchback.

FIG. 2 illustrates the conveyance section 100. The conveyance section conveys the sheet P onto which the fixing process has been performed by the fixing device 24. The conveyance section 100 includes a straight sheet ejection section 101, a reversal conveyance section 102 that branches out from the straight sheet ejection section 101, a reversal sheet ejection section 103 that ejects the sheet P whose front and back are reversed to the outside of the image forming apparatus and a sheet re-feeding section 104 that feeds the sheet that has been reversed into the image forming apparatus.

The reversal conveyance section 102 is a conveyance path that the sheet P passes through when the conveyance direction is reversed and conveyed in a reversal sheet ejection mode. In a case when the length of the sheet in the conveyance direction is not less than a predetermined length, the sheet P is conveyed to the sheet re-feeding section 104 at the time of reversal sheet ejection.

In this case, a part of the sheet re-feeding section 104 functions as the reversal conveyance section 102. That is, a part of the sheet re-feeding section 104 becomes the reversal conveyance section 102. A pair of registration rollers 122, which will be mentioned later, is arranged in the section where this sheet re-feeding section 104 functions as the reversal conveyance section 102.

The sheet P onto which the fixing process has been performed by the fixing device 24 is guided to the straight sheet ejection section 101 or to the reversal conveyance section 102 by a switching gate 106.

The straight sheet ejection section 101 includes four spur rollers 110 that guide the upper surface of the sheet P and a guide member 111 that guides the under surface of the sheet P.

The spur rollers 110 are guide members that come in point contact with the sheet P. Even in a case when it is immediately after the fixing processing and the wax forming the toner image is not yet fully solidified, the sheet P is guided without disturbing the appearance of the image surface by the contact of the rollers.

The reversal conveyance section 102 includes guide members 112, 114, 115, 117, 118, 120 and 121 and pairs of conveyance roller 113, 116 and 119.

The guide members 112, 114, 115, 117, 118, 120 and 121 are plate-shaped guide members.

A pair of conveyance rollers 113 is a pair of rollers having a conveyance surface that is not less than the width of the maximum size of the sheet P (the length in direction that is perpendicular to the conveyance direction). The pair of conveyance rollers 113 is configured by a driving roller 113A and a driven roller 113B.

The driving roller 113A is a rubber roller. The driven roller 113B is a metal roller made out of stainless steel.

The driven roller 113B cut into the driving roller 113A. The pair of conveyance rollers 113 gives a curvature to the sheet P that passes through and corrects the curl of the sheet P.

A sheet sensor SE1 is arranged above the pair of conveyance rollers 113 in the reversal conveyance section 102.

The reversal sheet ejection section 103 includes plate-shaped guide members 111 and 115.

As illustrated, the guide member 111 configures a guide member of the reversal conveyance section 102 with one side. Then the other side of the guide member 111 configures a guide member of the reversal sheet ejection section 103.

The upper section of the guide member 115 configures a guide member of the reversal sheet ejection section 103. The lower section of the guide member 115 configures a guide member of the reversal conveyance section 102.

The sheet re-feeding section 104 includes the pair of registration rollers 122, a number of pairs of conveyance rollers and a number of guide members. The sheet re-feeding section 104 is configured by a sheet re-feeding path 104A and a reversal path 104B.

As described above, in case when the length of the sheet P in the conveyance direction is not less than a predetermined length, a part of the sheet re-feeding section 104 becomes the reversal conveyance section 102.

The pair of registration rollers 122 is arranged at the sheet re-feeding section 104. The place where the pair of registration rollers 122 is arranged is a place that becomes the reversal conveyance section 102 in case when the length of the sheet P in the conveyance direction is not less than a predetermined length. A sheet sensor SE2 is arranged in the upper stream of the pair of registration rollers 122 in the sheet re-feeding section 104. At the time of double-sided image formation, the pair of registration rollers 122 determines the timing of re-feeding the sheet P into the image forming unit based on a detection signal of the sheet sensor SE2.

The pair of registration rollers 122 has a roller width that is not less than the width of the maximum size of the sheet P (the length in direction that is perpendicular to the conveyance direction). The pair of registration rollers 122 is configured by a driving roller 122A and a driven roller 122B.

It is preferable for the driving roller 122A to be a rubber roller and for the driven roller 122B to be a metal roller made out of stainless steel. However, the driven roller 122B may be a resin roller.

In the sheet ejection mode in which the sheet P that has passed through the fixing device 24 and onto which the fixing process was performed is ejected from the pair of sheet ejection rollers 105, the straight sheet ejection section 101 is selected by the switching gate 106.

In one-sided image formation, the sheet P is ejected in a state in which the image supporting surface faces up.

In double-sided image formation, after forming an image on the back surface, the sheet P is ejected in a state in which the back side of the sheet faces up.

In the reversal sheet ejection, the sheet P is guided to the reversal conveyance section 102 by the switching gate 106. Then the conveyance direction of the sheet P is reversed by a rear edge of sheet passage signal of the sheet sensor SE1. The sheet P is conveyed to the reversal sheet ejection section 103. Then the sheet P is ejected from the pair of the sheet ejection rollers 105. The above mentioned case of when the length of the sheet P in the conveyance direction is not less than a predetermined length is to be a case where the leading edge of the sheet P has reached to the sheet re-feeding section 104 when the sheet sensor SE1 detects the passage of the rear edge of the sheet P. In this case, a part of the sheets P passes through the position of the pair of registration rollers 122.

In the double-sided image formation, the sheet P onto which a surface image has been fixed is conveyed to the reversal path 104B of the sheet re-feeding section from the reversal conveyance section 102. In the double-sided image formation, the pair of registration rollers 122 provided in the sheet re-feeding section 104 is in a conveyance state in which the driving roller 122A and driven roller 122B are in contact with each other. Then the pair of registration rollers 122 nips and conveys the sheet P to the image forming section.

The sheet P whose conveyance direction has been reversed by the rear edge of sheet passage signal of the sheet sensor SE2 is fed into the image forming section through the sheet re-feeding path 104A.

The pairs of conveyance rollers 113, 116 and 119, which are configured by a driving roller and a driven roller, are arranged in the conveyance section 100 described above.

The pair of registration rollers 122 is arranged in the sheet re-feeding section 104.

As mentioned above, both of the pair of conveyance rollers 113 and the pair of registration rollers 122 are configured by a rubber roller (113A, 122A) and a metal roller (113B, 122B).

Each of the pairs of conveyance rollers 116 and 119 is configured by a large diameter driven roller made of a rubber roller and a small diameter driven roller made of a resin roller.

A case in which the length of the sheet P in the conveyance direction is not less than a predetermined length and the leading edge of the sheet P reaches the sheet re-feeding section 104 when the sheet sensor SE1 detects the passage of the rear edge of the sheet P in the reversal sheet ejection mode will be described henceforth. That is, a case in which a part of the sheet P passes the position of the pair of registration rollers 122 when performing a switchback to the sheet P in the reversal sheet ejection section 102 will be described. As for the toner image formed with the toner containing wax, the wax that exists on the surface of the toner image is not fully solidified immediately after fixing process.

Thus, in case when the toner image whose wax is not fully solidified is rapidly cooled, the wax crystallizes and the surface of the toner image takes on the glossiness.

Just as the pairs of conveyance rollers 116 and 119, in case when resin comes in contact with the image surface immediately after the fixing process, the image is not rapidly cooled. Therefore, the glossiness of the image surface does not notably increase by passing through the pairs of conveyance rollers 116 and 119.

In case when the metal roller comes in contact with the image surface as in the driven roller 113B of the pair of conveyance rollers 113 and the driven roller 122B of the pair of registration rollers 122, the glossiness of the image surface increases as a result of the wax that exists on the surface of the image being rapidly cooled.

Since the sheet P passes through the pair of conveyance rollers 113 up to the rear edge of the sheet P, even in case when the glossiness of the image is increased by the pair of conveyance rollers 113, the entire surface of the sheet P will finish with a mirror surface. Therefore, the deterioration of image quality seldom occurs because of the mirror surface finish.

On the other hand, the pair of registration rollers 122 comes partially in contact with the sheet P.

That is, in the reversal sheet ejection mode, when reversing the sheet P from a conveyance direction W1 in the introductory stage of the sheet P to a conveyance direction W2 in the ejection stage of the sheet P, as illustrated in FIG. 3, the driven roller 122B of the pair of registration rollers 122 comes in contact with a section PA of the image supporting surface of the sheet P on the right-hand side of the pair of registration rollers 122. However, the driven roller 122B does not come in contact with a section PB on the left side.

Therefore, the section PA is finished with a mirror surface. However, the section PB is not finished with a mirror surface. As a result, the glossiness of the image surface becomes uneven and the image quality deteriorates.

In the present invention, to prevent the above mentioned quality deterioration, just as in the pair of registration rollers 122, a pressure contact of a pair of conveyance rollers that comes partially in contact with the sheet P is released and the driven roller 122B is switched to an evacuated state in which the driven roller 122B separates itself from the image supporting surface of the sheet P.

The image supporting surface of a sheet refers to a side of the sheet P that supports a toner image immediately after the fixing process was performed to the sheet P.

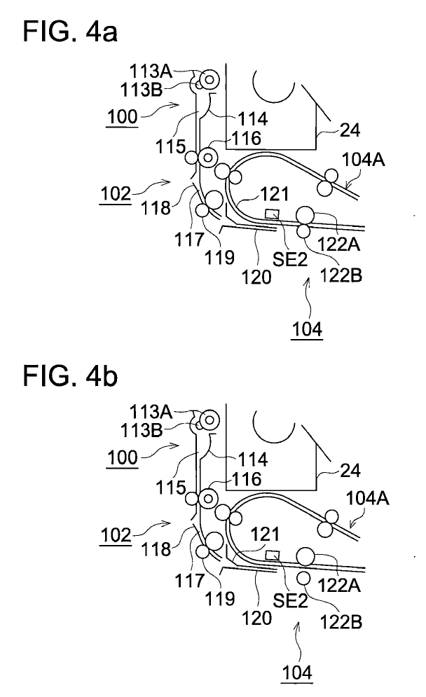

FIGS. 4a and 4b illustrate respectively a conveyance state and an evacuated state of the pair of registration rollers 122. FIG. 4a illustrates the conveyance state in which the pair of registration rollers 122 conveys the sheet P.

That is, the driving roller 122A and the driven roller 122B come in contact with each other, nip and convey the sheet P by the rotation of the driving roller 122A.

FIG. 4b illustrates the evacuated state of the pair of registration rollers 122. The driven roller 122B separates itself from the driving roller 122A. Therefore, the pair of registration rollers 122 does not convey the sheet P. The driven roller 122B is separated from the image supporting surface of the sheet P. As illustrated in FIG. 4b, even in a case in which the sheet P is not conveyed by the pair of registration rollers 122, the sheet P is conveyed by other rollers, such as the pair of conveyance roller 113. Therefore, the conveyance of the sheet P is possible.

The mirror surface finish of the sheet P varies by the wax content of the toner forming the image, by the quantity of the toner forming the image and by the quality of the sheet. Therefore, variety of timing of releasing the pressure-contact of the pair of conveyance rollers, such as the pair of registration rollers, can be considered. For example, releasing the pressure contact of the pair of registration rollers 122 only at the stage in which the sheet is introduced into the reversal conveyance section 102 at the time of the reversal conveyance can be considered. Releasing the pressure contact of the pair of registration rollers 122 only at the stage in which the sheet is ejected from the reversal conveyance section 102 at the time of the reversal conveyance can be considered. Thus, it becomes possible to suppress the deterioration of the image quality by releasing the pressure contact of the pair of registration rollers 122 only at the stage in which the sheet is introduces into the reversal conveyance section 102 or at the stage in which the sheet is ejected from the reversal conveyance section 102. In both the sheet introduction stage and the sheet ejection stage at the time of the reversal sheet ejection, it is also possible to release the pressure contact of the pair of registration rollers 122. In this case, it becomes possible to further suppress the deterioration of the image quality.

In order to prevent the uneven glossiness furthermore, the roller surface is formed into a rough surface by adhering glass bead or ceramic powder onto the surface of the driven roller 122B being the roller that comes partially in contact with the image supporting surface of the sheet P. It is preferable to control the mirror surface finish that results from the contact of the driven roller 122B.

With respect to such surface roughening material, a material whose average particle diameter is 65-300 μm is preferred.

The above mentioned reversal sheet ejection control that prevents the deterioration of the image quality by releasing the pressure contact of the pair of registration rollers 122 will be described below.

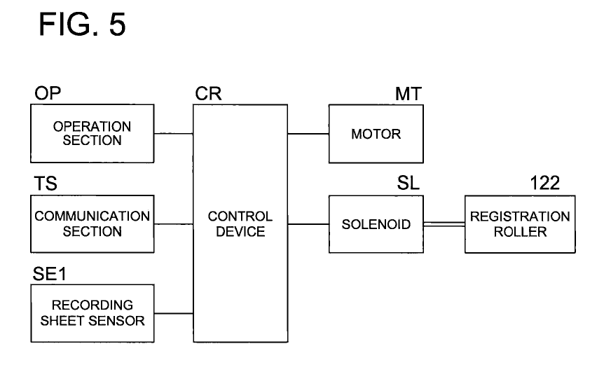

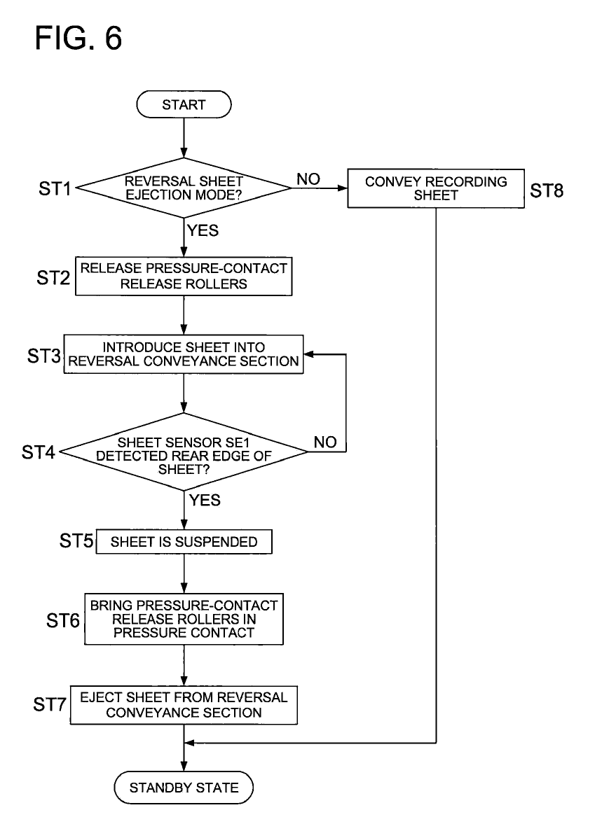

FIG. 5 illustrates a block diagram of a control system. FIGS. 6 to 8 illustrate a flow chart of the reversal sheet ejection control.

A control device CR as a switching device controls a solenoid SL, and switches the state of the pair of registration rollers between the conveyance state and the evacuated state based on the sheet ejection mode information from a communication section TS that receives a command from an operation section OP or an external apparatus. The control device CR performs a reversal sheet ejection control of the sheet P or switching of the above mentioned states of the pair of registration rollers 122 based on a rear edge of a sheet detect signal of the sheet sensor SE1.

FIG. 6 illustrates a flow chart showing a first example of the reversal sheet ejection control.

In STEP ST1, the control device CR determines whether the sheet ejection mode is the reversal sheet ejection mode based on the information from the communication section TS or from the operation section OP. In case when the sheet ejection mode is the reversal sheet ejection (Y), the control device CR operates the solenoid SL and releases the pressure contact of the pair of registration rollers 122 (ST2). That is, the pair of registration rollers 122 is set to the evacuated state.

The pair of registration rollers 122 is usually in pressure contact with each other. That is, in case when the solenoid SL is turned off, the pair of registration rollers 122 is in pressure contact with each other and is in the conveyance state. The pressure contact is released when the solenoid SL is turned on.

The conveyance of a sheet is performed in a state in which the pressure contact of the pair of registration rollers 122 is released [the state in FIG. 4b] (ST3).

At the time when the sheet sensor SE1 detects the passage of the rear edge of the sheet (Y of ST4), a motor MT is stopped to suspend the conveyance of the sheet (ST5). The motor MT drives each of the pairs of conveyance rollers 113, 116 and 119.

After the conveyance was suspended, the solenoid SL is turned off and the pair of registration rollers 122 are put in pressure contact with each other [ST6, the state of FIG. 4 (a)].

After STEP ST6, the motor MT is started in reverse, and the conveyance direction is reversed. Then the sheet is conveyed and ejected from the reversal sheet ejection section 103 to the pair of sheet ejection rollers 105.

In case when the sheet ejection mode is determined not to be the reversal sheet ejection mode in STEP ST1 (N of ST1), the pair of conveyance rollers in the conveyance section 100 continues to operate and to convey the sheet.

In N of STEP ST1, the pair of registration rollers 122 is in the conveyance state in which the pair of registration rollers 122 is in pressure contact with each other. The pair of registration rollers 122 nips and conveys the sheet. N of STEP ST1 is in a face-up sheet ejection or double-sided image formation mode.

At the time of image formation in the face-up sheet ejection or the completion of the double-sided of image formation in the double sided mode, the sheet is conveyed from the straight sheet ejection section 101 to the pair of sheet ejection rollers 105.

At the time of the first surface image formation in the double-sided image formation mode, the sheet is conveyed from the reversal conveyance section 102 to the sheet re-feeding section 104.

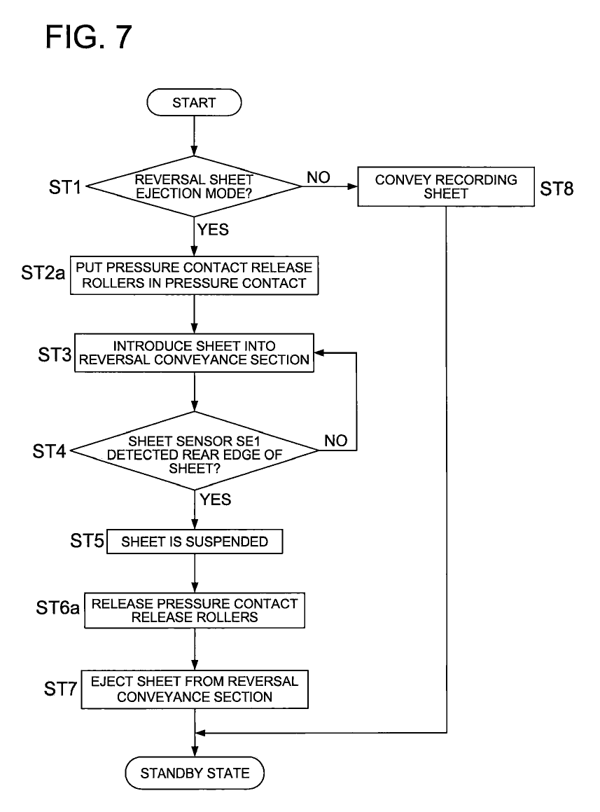

FIG. 7 illustrates a flow chart of a second example of the reversal sheet ejection control.

In the example of FIG. 7, STEP ST2a differs from STEP ST2 of FIG. 6. STEP ST6a also differs from STEP ST6 of FIG. 6. The other steps are the same as that of FIG. 6.

In STEP ST2a, the control device CR turns off the solenoid SL and puts the pair of registration rollers 122 in pressure contact with each other.

In STEP ST6a, the control device CR operates the solenoid SL and releases the pressure contact of the pair of registration rollers 122.

That is, in the example of FIG. 7, when introducing a sheet into the reversal conveyance section 102 and the sheet re-feeding section 104, the pair of registration rollers 122 is put into the conveyance state. Further, in case when ejecting the sheet from the reversal conveyance section 102 and the sheet re-feeding section 104, the pair of registration rollers 122 is put into the evacuated state.

The pair of registration rollers 122 is in pressure contact with each other when the solenoid SL is turned off. Then the pressure contact of nipping of the pair of registration rollers 122 is released when the solenoid SL is turned on. Therefore, STEP ST2a is in fact not an execution procedure, but a verifying procedure.

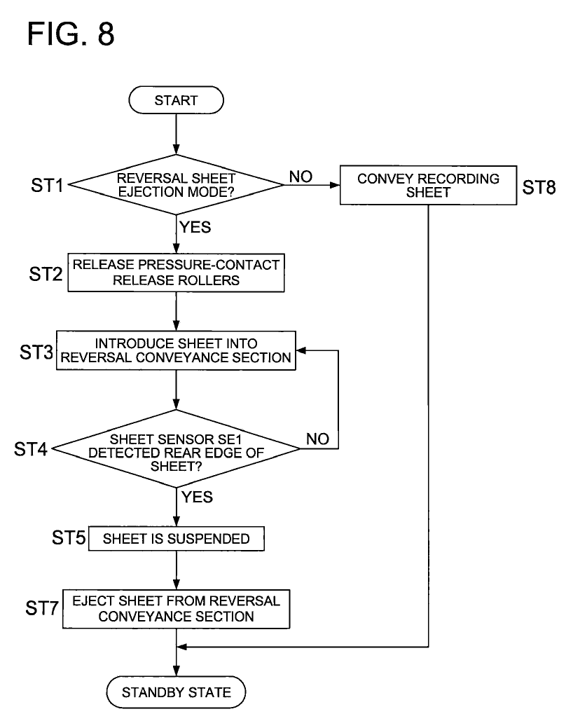

FIG. 8 is a flow chart of a third example of the reversal sheet ejection control.

The only difference between the examples of FIG. 8 and FIG. 6 is that STEP ST6 does not exist in the example of FIG. 8.

In FIG. 8, the sheet introduction in STEP ST3 and the sheet ejection in STEP ST7 are performed in a state in which the pressure contact of the pair of registration rollers 122 is released.

In the embodiments of the present invention, the switching device switches the conveyance device, which contacts the sheet and conveys the sheet, to the evacuated state in which the conveyance device is separated from the sheet at the time when reversing the conveyance direction of the sheet.

Therefore, it becomes possible to fully stop the uneven glossiness of a toner image. Thus, the deterioration of the image quality from the uneven glossiness of the toner image can be sufficiently prevented.

What is claimed is:

1. An image forming apparatus comprising:
an image forming section for forming a toner image on a sheet;
a fixing device for fixing the toner image on the sheet with heat;
a reversal conveyance section which reverses a conveyance direction of the sheet which has passed through the fixing device;
a conveyance member provided at the reversal conveyance section, the conveyance member changed to be in either one of a conveyance state in which the conveyance member is in contact with an image supporting surface of the sheet, and an evacuated state in which the conveyance member is separated from the image supporting surface of the sheet; and
a switching mechanism for switching the conveyance member to be in one of the conveyance state and the evacuated state.

2. The image forming apparatus described in claim 1,
wherein the switching mechanism switches the conveyance member to the evacuated state, when the sheet is introduced into the reversal conveyance section.

3. The image forming apparatus described in claim 1,
wherein the switching mechanism switches the conveyance member to the evacuated state, when the sheet is conveyed out from the reversal conveyance section.

4. The image forming apparatus described in claim 1,
wherein the switching mechanism switches the conveyance member to the evacuated state, when the sheet is introduced into the reversal conveyance section and when the sheet is conveyed out from the reversal conveyance section.

5. The image forming apparatus described in claim 1,
wherein the conveyance member comprises a pair of rollers which nips and conveys the sheet.

6. The image forming apparatus described in claim 5,
wherein at least one of the pair of rollers has a surface adheres glass beads or ceramic powder thereon.

7. The image forming apparatus described in claim 1,
further comprising: a sheet re-feeding section which re-feeds the sheet to the image forming section in a double-sided image formation, wherein the sheet conveyance member is provided at a position where a part is common for the sheet re-feeding section and the reversal conveyance section.

8. The image forming apparatus described in claim 7,
wherein the sheet conveyance member is a pair of rollers which decides a timing of re-feeding the sheet.
